(19) United States
(12) Patent Application Publication
(10) Pub. No.: US 2017/0215259 A1
(43) Pub. Date: Jul. 27, 2017

(54) SYSTEM FOR ALTERNATING LIGHT-EMITTING OF SOLID STATE DISC

(71) Applicant: AVEXIR TECHNOLOGIES CORPORATION, Zhubei City (TW)

(72) Inventors: Han-Hung CHENG, Zhubei City (TW); Wei-Di CHENG, Zhubei City (TW); Shih-Hsiu YEH, Zhubei City (TW)

(21) Appl. No.: 15/008,016

(22) Filed: Jan. 27, 2016

(51) Int. Cl. H05B 37/02; F21V 8/00; H05B 33/08

(52) U.S. Cl. CPC H05B 37/0272; H05B 33/0857; G02B 6/0011; H05B 33/0845

(57) ABSTRACT

A system for alternating lighting-emitting of solid state disc (SSD) is provided, including a plurality of SSDs and an application program. Each SSD includes a processing unit and a lighting-emitting unit. The processing unit is able to trigger the lighting-emitting unit to emit light in a preset mode. The lighting-emitting units define a lighting-emitting module. The application program is installed in a mobile electronic device. The application program sends a signal to the processing units of the SSDs via the mobile electronic device to match with and identify the SSDs, and the application program can make each said processing unit control the light-emitting unit to emit light and make the light-emitting module emit light in a preset mode.

### BACKGROUND OF THE INVENTION

Field of the Invention

The present invention relates to a system for alternating light-emitting of solid state disc (SSD).

Description of the Prior Art

Usually, a solid state disc (SSD) as disclosed in TWM508102 has a substrate, a flash memory module, at least light-emitting diode and at least one light-guiding portion. The substrate has a transmission port; the flash memory module is disposed on the substrate, and the flash memory module is electrically connected with the transmission port; the at least one light-emitting diode is disposed on the substrate, and the at least one light-emitting diode is electrically connected with the transmission port; and the at least one light-guiding portion at least partially covers the at least one light-emitting diode.

However, when this type of prior art is in actual practice, variation of the light-emitting diode is monotonous and is not pleasant to the eye.

On the other hand, in the SSD sold on the market, a frequency, a color and a mode of the light-emitting diode emitting light and flashing are fixed, and a user cannot adjust a light-emitting mode according to his/her needs or requirements.

The present invention has arisen to mitigate and/or obviate the afore-described disadvantages.

### SUMMARY OF THE INVENTION

The major object of the present invention is to provide a system for alternating light-emitting of solid state disc (SSD), wherein an application program can be used to control a light-emitting mode of a SSD to meet a user's requirements and preferences.

To achieve the above and other objects, a system for alternating light-emitting of SSD is provided, including a plurality of SSDs and an application program.

Each SSD includes a processing unit and a light-emitting unit, the processing unit can trigger the light-emitting unit to emit light in a preset mode, the light-emitting units define a lighting-emitting module. The application program is installed in a mobile electronic device. The application program sends a signal to the processing units of the SSDs via the mobile electronic device to match with and identify the SSDs, and the application program can make each said processing unit control the light-emitting unit to emit light and make the light-emitting module emit light in a preset mode.

Thereby, the system of the present invention allows the user to control and design the light-emitting mode of the SSD through mobile electronic device (for example, a smart phone) in accordance with his/her requirements or preferences.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a perspective view of a solid state disc of the present invention;

FIG. 2 is a perspective breakdown view of the solid state disc of the present invention; and

FIG. 3 is a sketch showing a system of the present invention.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

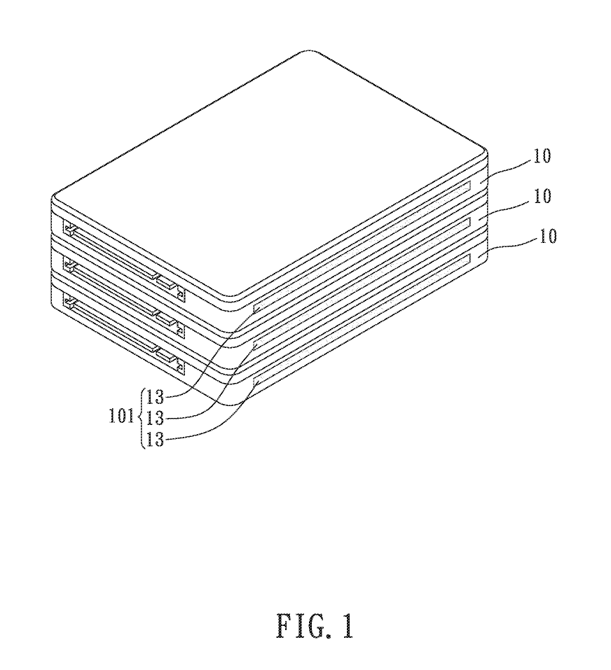

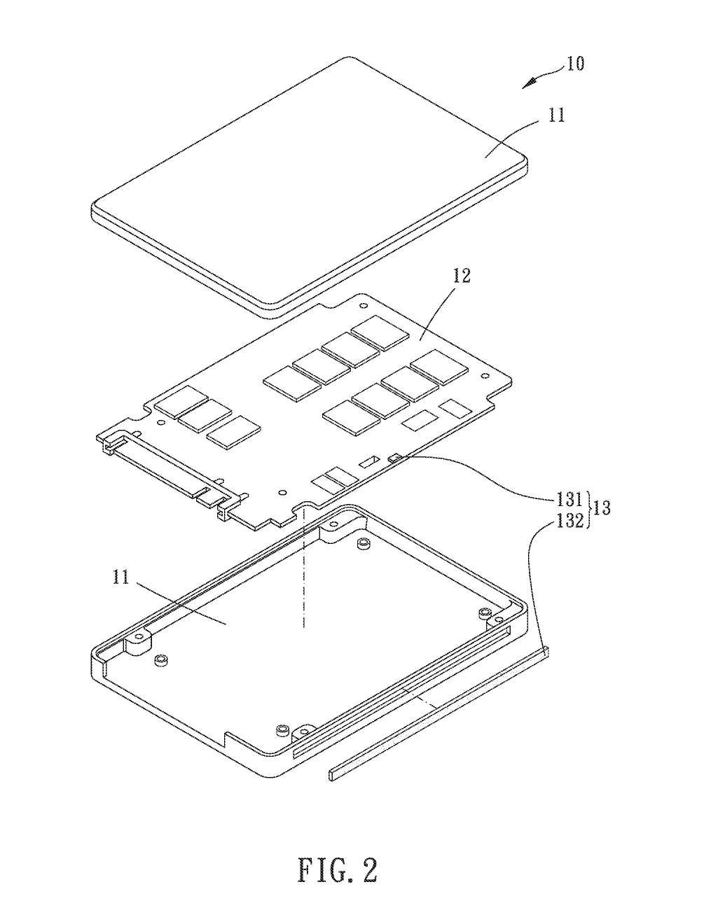

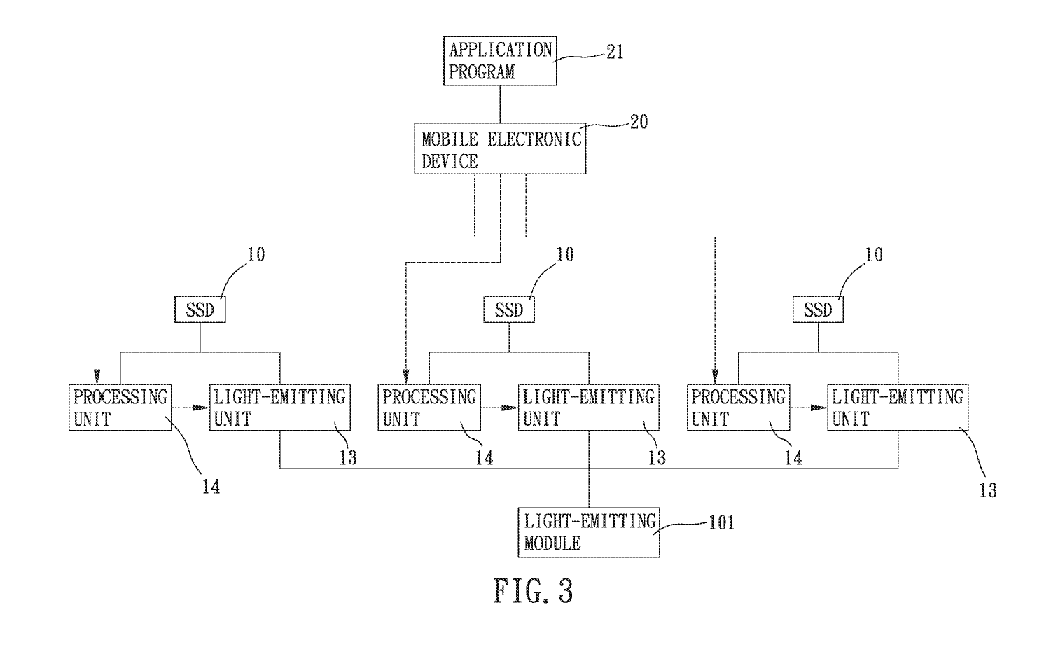

Please refer to FIGS. 1 to 3 for a system for alternating light-emitting of solid state disc (SSD) of the present invention, including a plurality of SSDs 10 and an application program 21.

Each SSD 10 includes a shell body 11, a main body 12, a processing unit 14 and a light-emitting unit 13. The main body 12, the processing unit 14 and the light-emitting unit 13 are received in the shell body 11, and the processing unit 14 can trigger the light-emitting unit 13 to emit light in a preset mode. Specifically, the processing unit 14 of each said SSD 10 can control a frequency, a color, a delay time and a flashing mode of light emitted from the light-emitting unit 13. Each said light-emitting unit 13 preferably includes at least one light-emitting diode 131, and more preferably, each said light-emitting unit 13 further includes at least one light-guiding member 132. The light-guiding member 132 is arranged neighboring to the light-emitting diode 131 and partially exposed so as to transmit light from the light-emitting diode 131 through the light-guiding member 132. Preferably, each said light-emitting unit 13 includes a plurality of light-emitting diodes 131, the light-emitting diodes 131 have different colors in emitting light, and the light-emitting units 13 define a light-emitting module 101. Preferably, the light-emitting units 13 are neighboring to each other. In addition, each SSD 10 may have connection ports which are commonly used. The application program 21 is installed in a mobile electronic device 20, the application program 21 can send out a signal through the mobile electronic device 20 to the processing units 14 of the SSDs 10 to match with and identify the SSDs 10 and make each said processing unit 14 control the light-emitting unit 13 to emit light and make the light-emitting module 101 emit light in the preset mode. Preferably, after each said processing unit 14 receives the signal from the mobile electronic device 20, the processing unit 14 triggers the light-emitting unit 13 to emit light in the preset mode circularly.

In actual practice, the user can purchase and assemble the SSDs 10 at will, and the processing unit 14 of each said SSD 10 can be built in with some specific light-emitting modes or set with various elements to be assembled (for example, each light-emitting duration time, an interval time between two light-emissions, light colors, a light-emitting intensity, a flashing frequency, and a delay time of light-emission). When the SSDs 10 are installed, the user can send a signal to the processing unit 14 (the processing unit 14 needs to be a device which can receive the signal, for example, a Bluetooth receiver or an infrared receiver) of the SSD 10 through wireless or remote communications (for example, Bluetooth communication or infrared communication) via the application program 21 (the application program 21 can be manufactured by a manufacturer of the SSD to be provided to the user) installed in the mobile electronic device 20 (for example, a smart cell phone or a tablet computer) so as to trigger the processing unit 14 to control the light-emitting mode of the light-emitting unit 13. More specifically, the application program 21 provides a simple interface to let the user choose one of the preset specific light-emitting modes. For example, suppose that the application program detecting three SSDs, the interface shows that there are three SSDs available for carrying out the light-emitting modes; and suppose that the user choosing the mode in which the three light-emitting units each flash three times per second, in turn, without the interval time and circularly. Actually, the application program sends a first one of the three SSDs a control signal which means zero delay time, flash three times per second and 2-second interval time between two light-emissions; the application program sends a second one of the three SSDs a control signal which means 1-second delay time, flash three times per second, 2-second interval time between two light-emissions; and the application program sends a third one of the three SSDs a control signal which means 2-second delay time, flash three times a second, 2-second interval time between two light-emissions. As a result, a light-emitting set of the three light-emitting units allows the light-emitting module to emit light in a specific mode.

The above description describes how the application program controls the light-emitting module to emit light in the preset mode; however, the light-emitting mode is not limited thereto. The application program may provide a customized interface to allow the user to design specific light-emitting modes and even a coloring interface to allow the user to control colors of light emitted from the light-emitting unit (different colors of the light-emitting diodes are controlled to emit light or not). The application program may even have additional functions, for example, to adjust the light-emitting patters through voice control.

Given the above, the system for alternating light-emitting of solid state disc allows the user to adjust the light-emitting mode of the light-emitting module. As a number of the SSD varies, various light-emitting modes can be provided, and the user can design the light-emitting modes and colors at will.

While we have shown and described various embodiments in accordance with the present invention, it should be clear to those skilled in the art that further embodiments may be made without departing from the scope of the present invention.

1. A system for alternating light-emitting of solid state disc (SSD), including:
a plurality of SSDs (solid state discs), each SSD including a processing unit and a light-emitting unit, the processing unit being able to trigger the light-emitting unit to emit light in a preset mode, the light-emitting units defining a light-emitting module;
an application program, for being installed in a mobile electronic device, the application program sending a signal via the mobile electronic device to the processing units of the SSDs so as to match with and identify the SSDs, to make each said processing unit control the light-emitting unit to emit light and to make the light-emitting module to emit light in a preset mode; wherein the processing unit of each said SSD is able to control a frequency, a color, a delay time and a flashing mode of light emitted from the light-emitting unit.

2. The system for alternating light-emitting of SSD of claim 1, wherein the light-emitting units are neighboring to each other.

3. The system for alternating light-emitting of SSD of claim 1, wherein each said light-emitting unit includes at least one light-emitting diode.

4. The system for alternating light-emitting of SSD of claim 3, wherein each said light-emitting unit further includes at least one light-guiding member, and the light-guiding member is located neighboring to the light-emitting diode and partially exposed so as to allow light from the light-emitting diode to transmit from the light-guiding member.

5. The system for alternating light-emitting of SSD of claim 3, wherein each said light-emitting unit includes a plurality of light-emitting diodes, the light-emitting diodes have different colors in emitting light.

6. (canceled)

7. The system for alternating light-emitting of SSD of claim 1, wherein after each said processing unit receives the signal from the mobile electronic device, the processing unit makes the light-emitting unit emit light in the preset mode circularly.

8. The system for alternating light-emitting of SSD of claim 1, wherein the processing unit contacts with the mobile electronic device through Bluetooth communication.

9. The system for alternating light-emitting of SSD of claim 1, wherein the processing unit contacts with the mobile electronic device through infrared communication.
